(19) United States
(12) Patent Application Publication
(10) Pub. No.: US 2003/0105881 A1
(43) Pub. Date: Jun. 5, 2003

(54) Method for detecting and preventing intrusion in a virtually-wired switching fabric

(76) Inventors: Julie Anna Symons, Santa Clara, CA (US); Sharad Singhal, Belmont, CA (US)

Correspondence Address: HEWLETT-PACKARD COMPANY, Intellectual Property Administration, P.O. Box 272400, Fort Collins, CO, 80527-2400, US

(21) Appl. No.: 10/005,066

(22) Filed: Dec. 3, 2001

(51) Int. Cl. G06F 15/16; H04L 12/56; H04L 12/28

(52) U.S. Cl. 709/249; 370/401; 370/911

(57) ABSTRACT

A method for detecting and preventing intrusion in a virtually-wired switching fabric. An embodiment provides for a method in which a switch is programmed with MAC addresses which are authorized for packets processed at each switch port, based on the device coupled to that switch port. If the MAC address is authorized, the packet is forwarded. If it is not, the packet is dropped. Furthermore, MAC addresses that are learned at a port connecting two switches in the fabric are compared to MAC addresses that are expected at that port, based on the physical topology of the network. If an unexpected MAC address is detected, the topology may be traced to locate the host port through which the packet with the unauthorized MAC address entered the virtual network. Additionally, the physical topology of the network may be periodically compared to the expected topology to detect unexpected changes.

### RELATED APPLICATION

This Application is a Continuation-in-Part of co-pending commonly-owned U.S. patent application Ser. No. ______, Attorney Docket No. HP-10013861, filed Oct. 4, 2001, entitled “A Method for Describing and Comparing Data Center Physical and Logical Topologies and Device Configurations” to Symons et al.

### TECHNICAL FIELD

The present invention relates to the field of computer network management. Specifically, the present invention relates to a method for detecting and preventing intrusion in a virtually-wired switching fabric.

### BACKGROUND ART

Data Centers are becoming a popular way to offer highly available business critical services to customers. The high demand for such data centers and economies of scale have led to centers containing thousands of devices. It is desirable to dynamically and securely partition and interconnect data center resources in a variety of topologies necessary for various applications required by data center customers. However, achieving security in such a network presents challenges. Two challenges with such networks are detecting and preventing intrusions in the network.

As one example of security breach, an unauthorized user can mimic an authorized computer by spoofing the host name and Internet Protocol (IP) address of the authorized computer. If the authorized computer is not currently on the network, there is no way of detecting this breach of security.

Another security issue is the difficulty in maintaining network topology information, which can be used to determine security issues related to network reconfiguration. A typical computer network is constantly being modified or reconfigured in some way. Typical maintenance activities such as moving users to a different physical location, adding or removing computer devices, device configuration changes, malfunctioning equipment as well as changes to the logical topology make it hard to differentiate between authorized changes and possible security violations. Frequently, changes are made to the infrastructure without properly documenting what changes have been made. The result of all of this activity is that over time, the network operator finds it increasingly difficult to detect any discrepancies between the expected state of the network infrastructure and its current state.

Furthermore, existing network management tools can provide huge amounts of data to a network operator. However, in displaying all of this information, a network operator can easily become overwhelmed by too much information. Furthermore, it is difficult to display all of this information at one time making it difficult for the operator to detect a possible security violation.

Accordingly, the present invention provides a method for detecting and preventing intrusion in a virtually-wired switching network. The present invention may detect and prevent such attacks which spring from inside the network. These and other advantages of the present invention will become apparent within discussions of the present invention herein.

### DISCLOSURE OF THE INVENTION

A method for detecting and preventing intrusion in a virtually-wired switching fabric is disclosed. An embodiment provides for a method in which first a packet is received at a switch port in the network, which may be a switched fabric. The switch may determine whether a MAC address associated with the packet is authorized for that port, based on the device coupled to that port. This may be a source MAC address of a device that sent the packet or a destination MAC address of a device that is to receive the packet. If the MAC address is authorized, the packet is forwarded. If it is not, the packet is dropped. Furthermore, a message indicating the unauthorized MAC address was detected may be generated.

Furthermore, MAC addresses that are learned at a port connecting two switches in the fabric are compared to MAC addresses that are expected at that port, based on the physical topology of the network. If an unexpected MAC address is detected, the topology may be traced to locate the host port through which the packet with the unauthorized MAC address entered the switching fabric.

Additionally, the physical topology of the network may be periodically compared to the expected topology to detect unexpected changes. In this fashion, changes to the network, such as, additional devices, moved devices, and removed devices may be discovered. Thus, potential intrusions may be detected (and prevented) by embodiments of the present invention.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a diagram of a virtually-wired switching fabric, according to an embodiment of the present invention.

FIG. 2 is a block diagram of an exemplary managed computer network system, according to an embodiment of the present invention.

FIG. 3 is a flowchart illustrating steps of a process for implementing host port filters, according to an embodiment of the present invention.

FIG. 4 is a flowchart illustrating steps of a process for filtering packets at a switch, according to an embodiment of the present invention.

FIG. 5 is a flowchart illustrating steps of a process for implementing switch interconnect filters, according to an embodiment of the present invention.

FIGS. 6A-6C are a flowchart illustrating steps of a process for topology re-discovery, according to an embodiment of the present invention.

### BEST MODE FOR CARRYING OUT THE INVENTION

In the following detailed description of the present invention, numerous specific details are set forth in order to provide a thorough understanding of the present invention. However, it will be obvious to one 5 skilled in the art that the present invention may be practiced without these specific details or by using alternate elements or methods. In other instances well known methods, procedures, components, and circuits have not been described in detail as not to unnecessarily obscure aspects of the present invention.

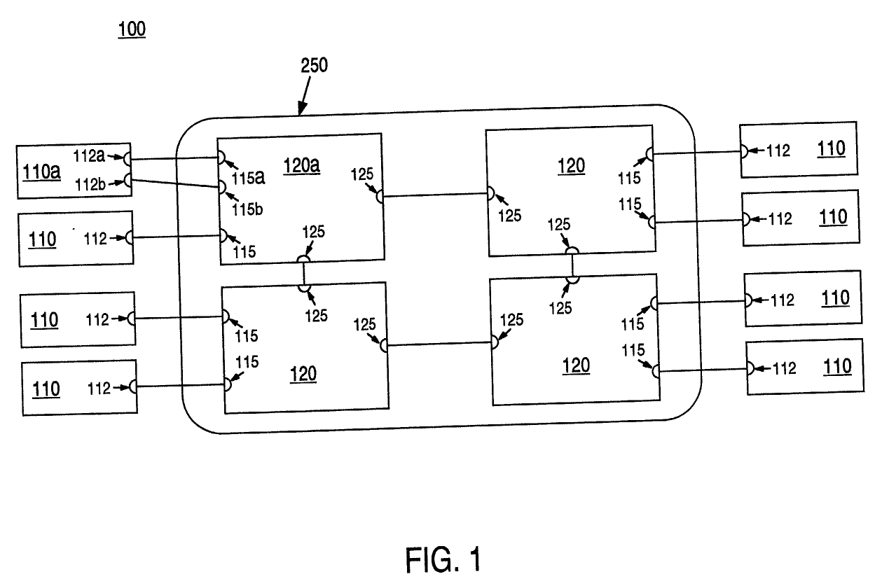

FIG. 1 is a diagram of a physical environment (e.g., network) 100 with a virtually-wired switching fabric 250. This may be a layer 2 Ethernet switching fabric, for example. A number of devices 110 (e.g., host devices 110) are coupled to the virtually-wired switching fabric 250, each through a single host port 115 on a switch 120. Thus, throughout this application the term host port 115 may be defined as a port on a switch 120 to which a device 110 outside the switching fabric 250 is connected. Each host port 115 is connected to only one host device 110. However, it is possible for a single host device 110 (e.g., host device 110a), which itself has multiple device ports 112 (e.g., device ports 112a, 112b), to be connected to multiple host ports 115 (e.g., host ports 115a, and 115b on switch 120a). Even in this case, there should be a one-to-one correspondence between host ports 115 and device ports 112. Thus, the network 100 does not rely upon the host devices 110 to determine the network 100 topology. Instead, the topology may be determined by configuring the switching structure. Switches 120 are coupled by interconnect ports 125.

The virtually-wired switching fabric 250 allows data center operators to control network connectivity at a more granular level by programming configurations into each switch 120 that determines the connections between devices 110. For example, the data center operators can create virtual topologies in which certain devices 110, though physically connected to the entire network 100, can communicate only with other designated devices 110. The logical topology of the network 100 can, for example, be changed using the switches 120 without physically touching any wiring. A switched network 100 allows gathering an inventory of network devices 110 because each device 110 can be located and identified according to the port 115 or ports 115 to which it is connected. The virtually-wired switching fabric 250 enhances network security because physical access to the virtually-wired switching fabric 250 is restricted and the switching fabric 250 can be programmed only by data center operators.

Throughout this application the term virtually-wired switching fabric 250 may be defined as a network that allows programming configurations into each switch 120 to determine the connections between devices 110, allowing virtual topologies in which certain devices 110, though physically connected to the entire network 100, can communicate only with other designated devices 110; and further allowing the logical topology of the network 100 to be changed using the switches 120 without physically touching any wiring.

Embodiments base detection and prevention of intrusion based on MAC addresses associated with packets processed at a given host port 115 or interconnect port 125. For example, each switch 120 may be programmed to take action based on one or more MAC addresses which it expects to see at a given host port 115. For example, switch 120a may be programmed to only allow packets with a MAC address associated with device port 112a to be processed at host port 115a. The MAC address may be a source MAC address for a packet received from the host device 110a and a destination MAC address for a packet to be sent to host device 110a. However, it will be understood that a switch 120 may expect to see more than one MAC address at a given host port 115. For example, host device 110a may have a second device port 112b that is coupled to a second host port 115b. This may be used as a backup if the connection formed by device port 112a and host port 115a fails. Thus, switch 120a may be programmed to allow transference of packets received at host port 115b with the MAC addresses associated with both device ports 112a and 112b.

Embodiments provide for a method to detect and prevent network intrusion in a network such as virtually-wired switching fabric 250. The present invention may be defined as comprising several components, for example, host port filters, interconnect port monitoring, and comparing expected topology to current topology, where current topology is rediscovered.

Embodiments provide for host port 115 filters, which may be implemented as a software program. For example, a software program may program (e.g., configure) a switch 120 to implement a host port filter. These host port filters serve to prevent a host device 110 from sending packets into the virtually-wired switching fabric 250 unless the source MAC address is authorized. Embodiments also prevent a host device 110 from receiving packets from the virtually-wired switching fabric 250 unless the destination MAC address is authorized.

Embodiments also provide for interconnect port 125 monitoring, which may be implemented as a software program. This monitoring compares the MAC addresses that each interconnect port 125 “learns” (e.g., MAC addresses that are associated with packets processed at an interconnect port 125) with a set of MAC addresses that are expected to be seen at that interconnect port 125, based on the network topology. If an unexpected MAC address is seen, this embodiment may trace the topology to find the host port 115 where the unexpected MAC address was “learned” (e.g., where the packet entered the virtually-wired switching fabric 250). Thus, corrective action may be taken, such as, for example, disabling the host port 115.

Embodiments also provide for topology re-discovery, which may be implemented via a software program. These embodiments may periodically re-discover the network physical topology and compare it with an expected topology to detect unexpected changes, which may indicate a security violation. The topology re-discovery also allows the host port filtering and interconnect monitoring processes to have the latest topology information so as to avoid dropping packets that should be allowed.

In a switched network, the hubs used to couple devices in the network are replaced with switches 120. Unlike hubs which share network segments, switches 120 provide a segment for each device 110 connected to it. By replacing the hubs with switches 120, devices 110 connected to the network 100 can be physically isolated and/or located by the data center operators because there is a one-to-one mapping between a given device 110 and the host port 115 to which it is connected. However, the present invention is not limited to a network which comprises switches 120 exclusively. Embodiments allow hubs and other such devices, although the ability to detect and/or prevent intrusions may be limited in such an environment.

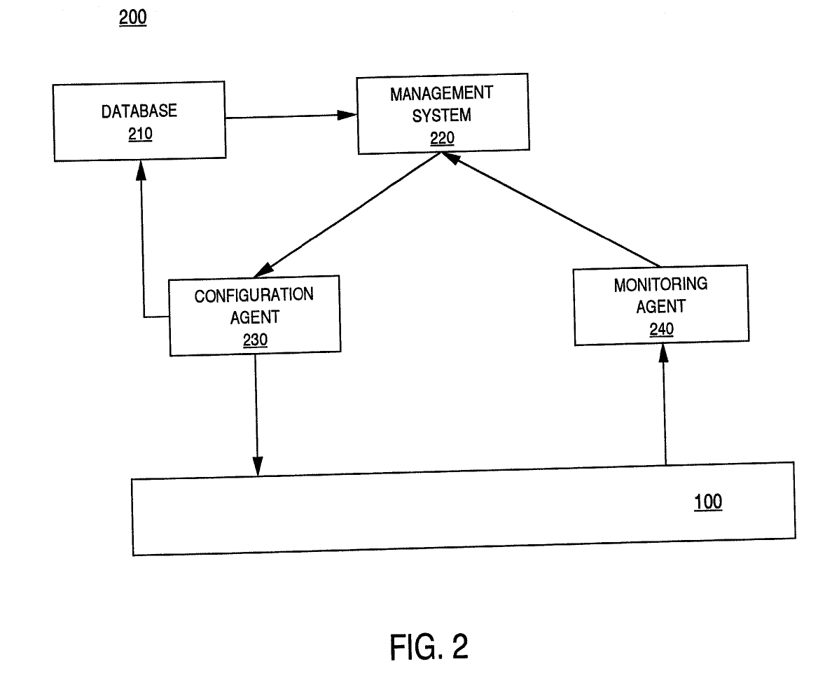

FIG. 2 represents a network 200 having a data center where central control over the network 200 can be maintained. In one embodiment, the physical environment 100 relies upon a switched network environment. For example, the physical environment comprises a virtually wired-switching fabric 250, along with devices 110. A database 210 for storing an expected network infrastructure description is coupled with a configuration agent 230 and a management system 220. The configuration agent 230 may store the configuration information in the database 210 as part of the expected network infrastructure description.

The monitoring agent 240 may re-discover network topology by periodically collecting current topology and configuration information of the physical environment 100 and sending this information to the management system 220. The monitoring agent 240 may also read the bridge table for the interconnect ports 125 of each switch 120 as part of interconnect port monitoring.

The management system 220 may read the database 210 to obtain expected MAC addresses and a list of interconnect ports 125 as part of host port filtering and interconnect port monitoring. The management system 220 may also instruct the configuration agent 230 to add host port filters (e.g., configure switches 120) based on the expected MAC address or addresses for packets processed at each host port 115.

The management system 220 may also compare the expected network infrastructure description with the current network infrastructure description and may automatically correct deviations or flag them to the data center operator as possible security violations.

The management system 220 may also reconfigure the logical topology of the physical environment 100 based on information about the current network infrastructure. For example, a device 110 with a high availability interface (e.g., a Network Interface Card (NIC) with two network connections or two separate NICS) and two physical connections to a switch 120 may be configured so that if one interface fails the other interface takes on the work of the first. Embodiments may allow the MAC address of the failed interface (e.g., device port 112a) to appear on the second interface (e.g., device port 112b) if it takes on the role of the failed interface. In one embodiment, the MAC address of the failed interface may be pre-assigned to the host filter of the second interface prior to the failure. For example, the management system 220 could allow the MAC address of both device ports (112a, 112b) at all times on both host ports (115a, 115b). (For example, both device MAC addressees 112a and 112b are added to both host port filters 115a and 115b.) Alternatively, the MAC address of the failed device may be reassigned dynamically. For example, the monitoring agent 240 would detect the failed interface and the management system 220, using the configuration agent 230, would reassign the MAC address to the second interface. The configuration agent 230 would then update the database 210 so that the reconfigured interface does not show up as a security breach in the network 100.

In the context of the present invention, creating a switched network in the physical environment 100 allows the data center operator to verify that devices 110 and host ports 115 are properly connected and configured by, for example, determining if a given device 110 is connected to the correct host port 115 or if it has been moved to another. It also allows the data center operator to detect and locate devices 110 which have been added to the network 100 or reconfigured without authorization or which were not properly entered into database 210 using configuration agent 230.

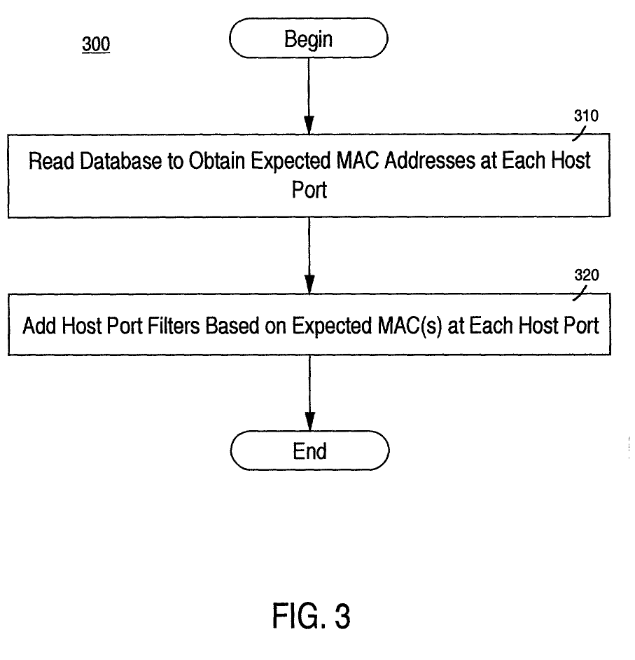

FIG. 3 is a flowchart of a process 300 for implementing a host port filter. Process 300 may be implemented in software using a computer-readable medium having instructions stored thereon, which when run on a processor, perform steps of process 300. In step 310, a database 210 is read to obtain a list of expected MAC addresses at each host port 115. For example, the management system 220 queries the database 210. Typically, a database uses the Structured Query Language (SQL) to construct a query.

However, SQL may not be not well suited for making side by side comparisons. Therefore, in one embodiment of the present invention, this description is formatted using the Extensible Markup Language (XML). XML is frequently used to present structured data such as a database in a text format. By formatting the description using XML, an XML data type description (DTD) can be used to describe a given device 110 in the network topology. For each device 110 in the topology, the description may include the name of the device 110 and its configuration attributes (e.g., the Media Access Control or MAC address of each port 112 or interface for the device 110) including a “linksTo” field identifying the host port 115 and the switch 120 to which it is connected.

In step 320, port host filters are added based on the expected MAC address or addresses at each host port 115. For example, the management system 220 instructs the configuration agent 230 to add host port filters by configuring the switches 120. For example, the switches 120 may be programmed to only process packets with the expected MAC addresses. Any suitable method may be used to program the switches 120, such as, for example, methods using the Simple Network Management Protocol (SNMP). Process 300 then ends. Process 300 may be repeated periodically, for example, at an interval set by the administrator. Alternatively, Process 300 may be triggered in the management system 220 when an agent discovers topology changes.

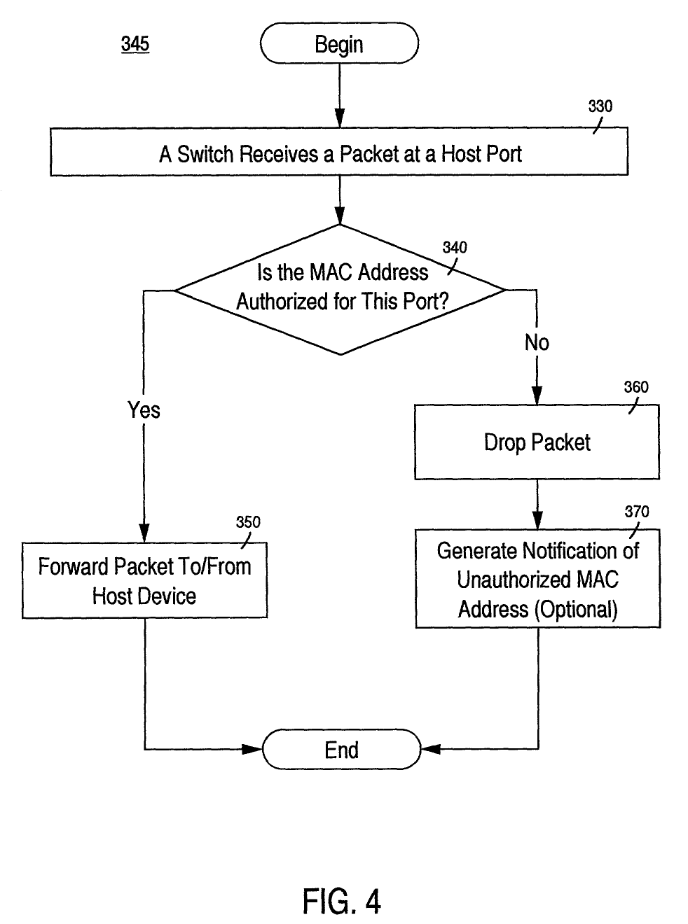

When a switch 120 receives a packet, it executes steps of Process 345 of FIG. 4. In step 330, a switch 120 receives a packet at a given host port 115. The packet may be entering or leaving the virtually switching wired fabric 250. Thus, not only may a host device 110 be prevented from sending packets into the virtually-wired switching fabric, but eavesdropping may also be prevented by monitoring packets destined to be sent out of the virtually-wired switching fabric 250 to a host device 110.

In step 340, the MAC address associated with the packet is compared to a list of expected MAC addresses for this host port 115. For example, the switch 120 will take action based on its programming. However, the present invention is not limited to this method of determining authorized MAC addresses. In one embodiment, the switch 120 uses the last set of authorized MAC addresses that were downloaded into the switch 120 by the management system 220 (e.g., as performed in step 320 of Process 300 of FIG. 3).

If the MAC address associated with the packet is authorized for this host port 115, the switch 120 forwards the packet from or to the host device 110, in step 350. The MAC address may be either a source or destination address. The process 345 then ends.

On the other hand, if the MAC address is not authorized for this host port 115, then the switch 120 drops the packet, in step 360. Then, in optional step 370, the switch 120 generates a notification of an attempt to transfer data to or from a host device 110 whose MAC address is not authorized for this host port 115. The process 345 then ends.

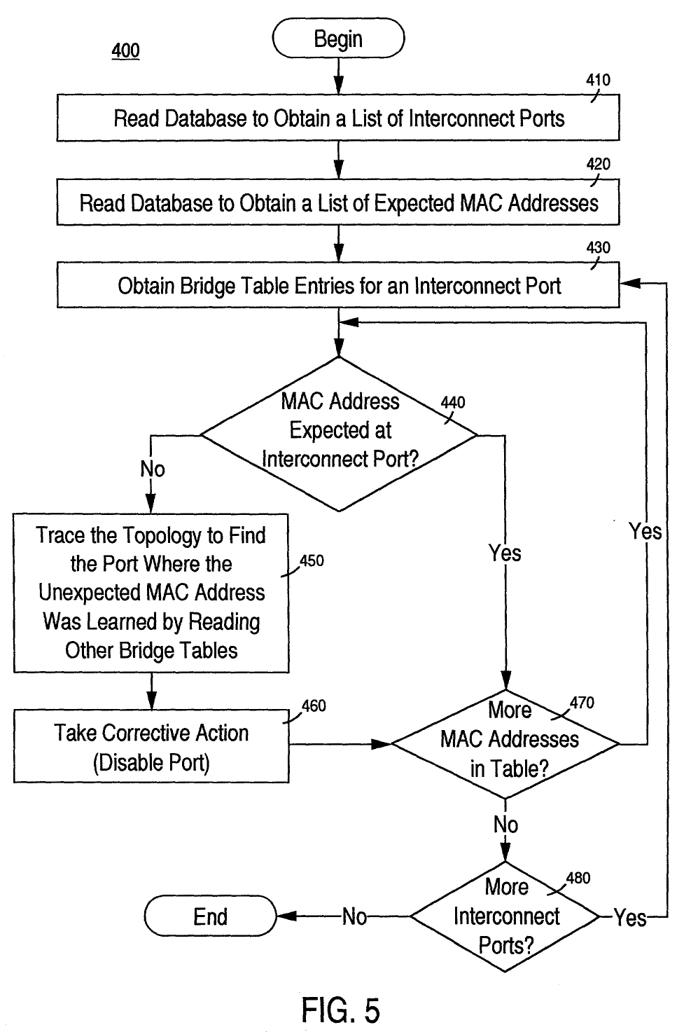

Embodiments also provide for interconnect port monitoring. FIG. 5 illustrates steps of a process 400 for performing interconnect port monitoring.

A computer-readable medium may have instructions stored thereon, which when run on a processor, perform steps of process 400. In step 410, the management system 220 reads the database 210 to obtain a list of interconnect ports 125.

Next, in step 420, the management system 220 reads the database 210 to obtain a list of expected MAC addresses based on the topology. In this fashion, the management system 220 may determine authorized MAC addresses that are expected to be present in the network 100.

In step 430, a bridge table is read to determine which MAC addresses were learned at interconnect port 125. For example, the management system 220 asks the monitoring agent 240 for the bridge table of each switch 120 of the virtually-wired switching fabric. For clarity, process 400 is described as processing one interconnect port 125 at a time and looping back from step 480 to step 430, until all interconnect ports 125 have been processed. However, in practice the management system 220 may read the bridge table once (or get the rows for all interconnect ports 125 at the same time) from the switch 120, then process each interconnect port 125.

In step 440, the management system 220 determines if a MAC address in the bridge table is on the expected list of MAC addresses for this interconnect port 125. For clarity process 400 is described as processing one MAC address at a time and looping back from step 470 to step 440 until all MAC addresses for the interconnect port 125 in this bridge table have been processed.

If the MAC address is not expected, then the topology is traced by reading bridge tables of other switches 120 to find the host port 115 where the unexpected MAC address was learned, in step 450. For example, the management system 220 may sequentially check the bridge tables of multiple switches 120 to discover the host port 115 where the unexpected MAC address entered the virtually-wired switching fabric 250.

Then in step 460, corrective action may be taken at the host port 115 where the unexpected MAC address entered the fabric 250. For example, the host port 115 may be disabled.

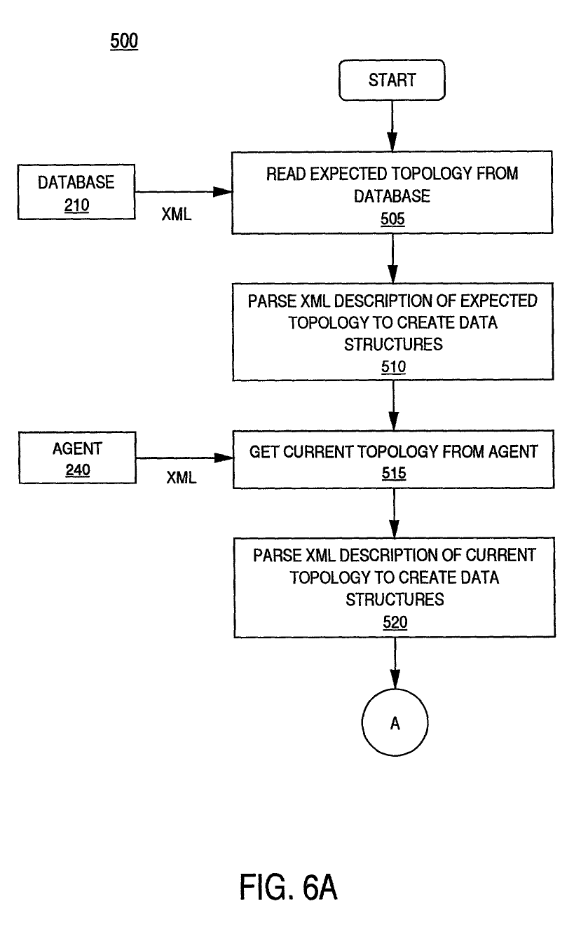

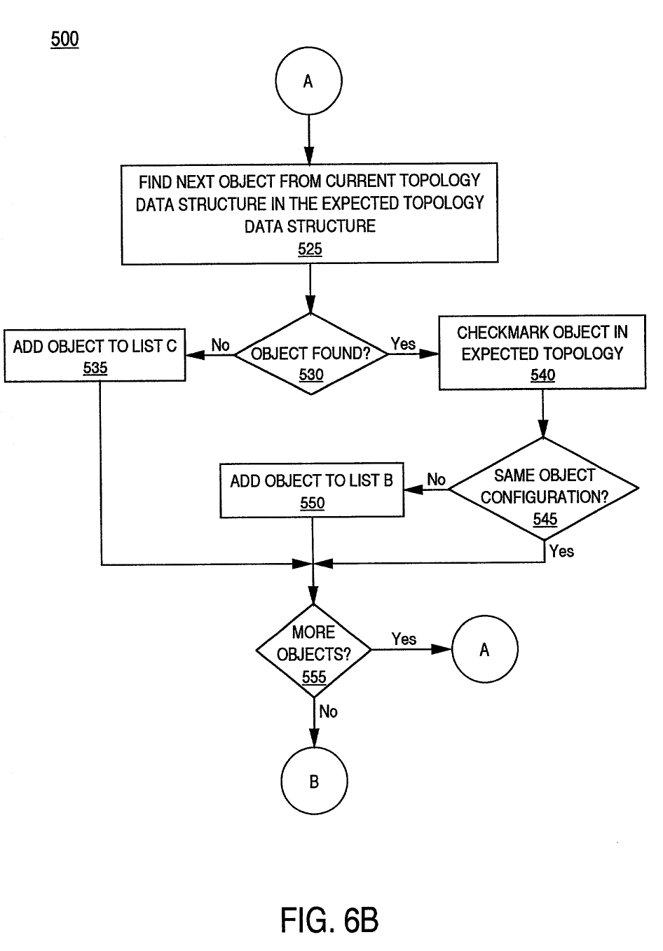

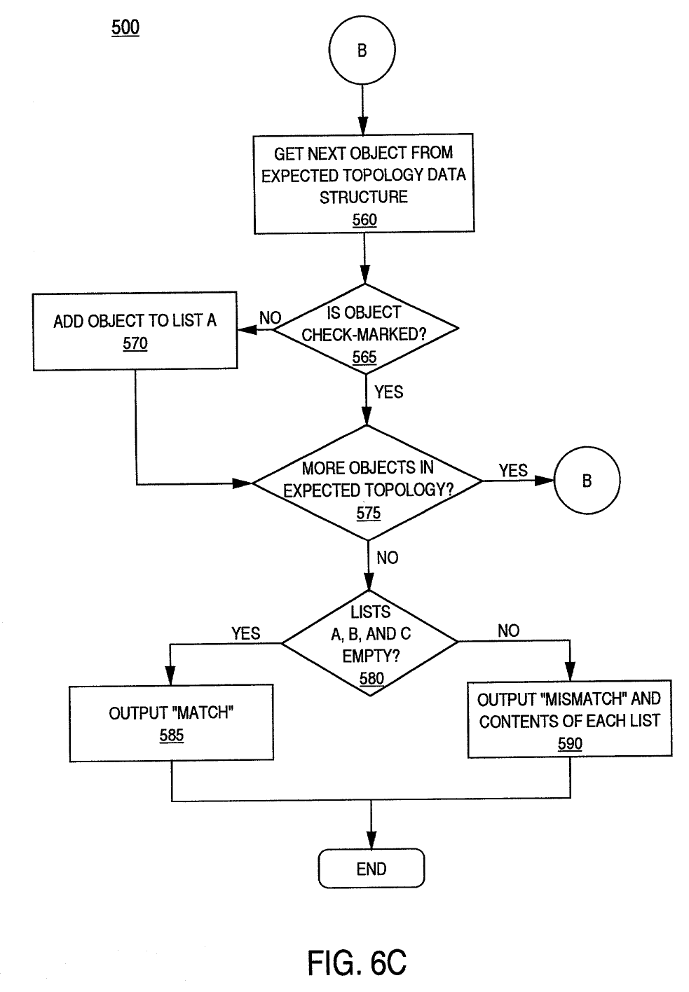

The Process 400 continues until all MAC addresses learned on each interconnect port 125 (e.g., according to each switch's bridge table) in the fabric 250 have been processed. Process 400 may be repeated at a sufficient interval such that every learned MAC address will be properly processed. For example, each bridge table may be read at an interval that is less than one-half of the MAC address age out limit. The network topology is periodically re-discovered and compared with an expected topology to detect unexpected changes. Furthermore, the new network topology is stored in database 210 to be used in process 300 and process 400 when implementing host port filters and interconnect port monitoring, respectively. FIGS. 6A-6C illustrate a flowchart of a process 500 for describing and comparing data center physical and logical topologies and device configurations in accordance with one embodiment of the present invention. Process 500 can be described as occurring in three phases. FIG. 6A shows the first phase in which the expected network infrastructure description and the current network infrastructure information are collected. In the second phase, which corresponds to FIG. 6B, devices 110 and switches 120 in the current infrastructure description are compared to devices 110 and switches 120 in the expected infrastructure description to detect any new devices 110 or switches 120 in the network or any changed configurations of devices 110 and/or switches 120 in the network. Additionally, this step looks for removed or failed devices 110 and switches 120 and failed interfaces. In the third phase, which corresponds to FIG. 6C, devices 110 and switches 120 in the expected infrastructure description are compared against the current infrastructure description to detect devices 110 and/or switches 120 that were removed from the network without updating the expected network infrastructure description. Also in the third phase, a report may be output describing any discrepancies between the infrastructure descriptions if there are any or, if there are no discrepancies, stating that the descriptions are identical. For purposes of clarity, the following discussion will utilize the block diagram of FIG. 2 in conjunction with FIGS. 6A-6C, to clearly describe an embodiment of the present invention.

With reference to FIG. 2 and to step 505 of FIG. 6A, the expected topology description is read from a database (e.g., database 210 of FIG. 2).

With reference to FIG. 2 and to step 510 of FIG. 6A, the XML description of the expected network infrastructure is parsed to create a graphical data structure. This graphical data structure represents the expected network infrastructure. Each device 110 and switch 120 are represented in a graph, where nodes represent devices 110 and switches 120, links represent the connections between those devices 110 and switches 120, and both nodes and links have attributes that represent the expected configuration of the device 110/switch 120 or connection.

With reference to FIG. 2 and to step 515 of FIG. 6A, the current network infrastructure description is collected. In one embodiment, the current infrastructure description is collected through the use of monitoring agents (e.g., monitoring agent 240 of FIG. 2) such as Simple Network Management Protocol (SNMP) agents that can query SNMP Management Information Bases (MIBs) on each physical device 110 and switch 120 in network 100. In another embodiment, the current network infrastructure is collected by a program in management system 220 which gathers the information from the devices 110 and switches 120 in network 100.

With reference to FIG. 2 and to step 520 of FIG. 6A, the XML description of the current network infrastructure is parsed to create a graphical data structure. As in step 510, a graph is created showing devices 110 and switches 120 in the current network infrastructure description and connections between those devices 110 and switches 120 to facilitate a comparison with the expected network infrastructure description. The graphs of the expected network infrastructure and the current network infrastructure will be compared to detect any differences.

With reference to FIG. 2 and to step 525 of FIG. 6B, a device 110 or switch 120 from the current network infrastructure graph is searched for in the expected network infrastructure graph. The graphical structure used permits this decision to be made with relatively few operations on the node by simultaneous traversal of the two graphs (current infrastructure graph and expected infrastructure graph) without a global search for the device 110 or switch 120.

With reference to FIG. 2 and to step 530 of FIG. 6B, a logic operation occurs to determine whether the device 110 or switch 120 in the current network infrastructure graph of step 525 was found in the expected network infrastructure graph. If the device 110 or switch 120 is found, process 500 next proceeds to step 540. If the device 110 or switch 120 is not found, it is considered a new device 110 or switch 120 and process 500 proceeds to step 535.

With reference to FIG. 2 and to step 535 of FIG. 6B, the device 110 or switch 120 from step 525 is added to list C. List C is a list of devices 110 and switches 120 in the current network infrastructure description which are not found in the expected network infrastructure description. By only reporting the differences between the two network infrastructure descriptions, the present invention allows a data center operator to quickly determine changes to the network infrastructure such as a new device 110 or switch 120 which has been added to the network without the database 210 being updated. Rather than having to compare huge inventory lists to detect differences in the network infrastructure, the data center operator is presented with a much smaller list of the infrastructure discrepancies.

With reference to FIG. 2 and to step 540 of FIG. 6B, the device 110 or switch 120 from step 525 is checked or otherwise marked in the expected network infrastructure graph as having been read. If the device 110 or switch 120 is found in the expected network infrastructure graph in step 530, the device 110 or switch 120 is marked in the expected network infrastructure description as having been found in the current network infrastructure description. These marks are used later in the process 500 to find missing devices 110 and switches 120 or links.

With reference to FIG. 2 and to step 545 of FIG. 6B, the current configuration of the device 110 or switch 120 from step 525 is compared to the configuration of the same device 110 or switch 120 in the expected network infrastructure description. If the device 110 or switch 120 has the same configuration in the current infrastructure description as in the expected infrastructure description, process 500 proceeds to step 555. If the configuration is different, process 500 proceeds to step 550.

With reference to FIG. 2 and to step 550 of FIG. 6C, the device 110 or switch 120 from step 525 is added to list B. List B is a list of network devices 110 and switches 120 which have a different configuration than what is found in the expected network infrastructure description. This can include hardware, firmware, and software configuration changes in network devices 110 and switches 120.

With reference to FIG. 2 and to step 555 of FIG. 6C, a logic operation occurs to determine whether there are more devices 110 and/or switches 120 in the current network infrastructure graph that have not been checked against the expected infrastructure graph. If there are more devices 110 and/or switches 120 in the current network infrastructure graph, process 500 returns to step 525. If there are no more unchecked in the current network infrastructure graph, process 500 proceeds to step 560.

With reference to FIG. 2 and to step 560 of FIG. 6C, a device 110 or switch 120 in the expected network infrastructure graph is selected for comparison. Devices 110 and switches 120 in the expected network infrastructure graph are now tested to discover devices 110 and switches 120 from the expected network infrastructure graph which are missing from the current network infrastructure graph. The expected network infrastructure graph is traversed and any node or link which is not check-marked is identified as missing or moved.

With reference to FIG. 2 and to step 565 of FIG. 6C, a logic operation occurs to determine whether the device 110 or switch 120 in the expected network infrastructure graph of step 560 has been checked or otherwise marked from step 540. This will indicate whether the device 110 or switch 120 in question is in both the expected description and the current description. If the device 110 or switch 120 has been checked, process 500 proceeds to step 575. If the device 110 or switch 120 has not been checked, process 500 proceeds to step 570.

With reference to FIG. 2 and to step 570 of FIG. 6C, the device 110 or switch 120 from step 560 is added to list A. List A is a list of devices 110 and switches 120 which are in the expected network infrastructure description which are not in the current network infrastructure description. This could be the result of a device 110 or switch 120 being moved, disconnected, or otherwise disabled.

With reference to FIG. 2 and to step 575 of FIG. 6C, a logic operation occurs to determine whether there are more devices 110 and/or switches 120 in the expected network infrastructure graph. If there are more devices 110 and/or switches 120 in the expected network infrastructure graph, process 500 returns to step 560. If there are no more devices 110 and switches 120 in the expected network infrastructure graph, process 500 proceeds to step 580.

With reference to FIG. 2 and to step 580 of FIG. 6C, a logic operation occurs to determine whether lists A, B, and C are empty. If lists A, B, and C are empty, process 500 proceeds to step 585. If lists A, B, and C are not empty, process 500 proceeds to step 590.

With reference to FIG. 2 and to step 585 of FIG. 6C, a statement or message may be output which indicates that the expected network infrastructure description matches the expected network infrastructure description. If lists A, B, and C are empty, that means that no differences between the expected network infrastructure description and the current network infrastructure description have been detected. A statement is output which states that the two network descriptions are identical.

With reference to FIG. 2 and to step 590 of FIG. 6C, a statement may be output which indicates that the expected network infrastructure description does not match the current network infrastructure description. This means that there is at least one discrepancy on either list A, B, or C which should be brought to the attention of the data center operator. By listing discrepancies between the two network infrastructure descriptions rather than all of the configuration information itself, the present invention reduces the amount of information a data center operator has to monitor and facilitates managing the network. The present invention further enhances network security by detecting unauthorized or reconfigured devices 110 and switches 120 and notifying the data center operator if any are present.

The preferred embodiment of the present invention, a method for detecting and preventing intrusion in a virtually-wired switching fabric, is thus described. While the present invention has been described in particular embodiments, it should be appreciated that the present invention should not be construed as limited by such embodiments, but rather construed according to the below claims.

What is claimed is:

1. A method of managing a network, said method comprising:
a) receiving a packet at a first port in said network, wherein;
b) determining if an address associated with said packet is authorized for said first port; and
c) forwarding said packet if said address is authorized.

2. The method of claim 1, further comprising:
d) dropping said packet if said address is not authorized.

3. The method of claim 1, wherein a) comprises receiving said packet from a device coupled to said first port, said first port being a switch port, and wherein there is a one-to-one mapping between ports of devices in said network and ports of switches in said network.

4. The method of claim 1, wherein c) comprises forwarding said packet to a device if said address is authorized for said first port, said first port coupled to said device, and wherein said network comprises a virtually-wired switching fabric.

5. The method of claim 1, further comprising:
d) comparing a set of learned addresses against a set of expected addresses, said learned addresses comprising addresses associated with packets received at a second port, said expected addresses derived from an expected configuration of said network.

6. The method of claim 5 wherein said second port couples two switches in a virtually-wired switching fabric.

7. The method of claim 6, further comprising:
e) tracing a topology of said network to find a third port where an unexpected address entered said virtually-wired switching fabric.

8. The method of claim 7, further comprising:
f) taking corrective action at said third port, said third port coupled to a device.

9. The method of claim 8, wherein f) comprises disabling said third port.

10. The method of claim 1, further comprising:
d) determining changes in physical topology of said network.

11. The method of claim 10 wherein d) comprises comparing a physical description of said network with a stored physical description of said network.

12. The method of claim 1 wherein said address is a media access control (MAC) address.

13. A computer-readable medium having stored thereon a program, which when run on a processor, performs a method of managing a network, said method comprising:
a) comparing addresses associated with packets received at a first port in said network with expected addresses for said first port to determine unexpected addresses; and
b) locating a second port in said network that is a source of an unexpected address if said unexpected address is detected.

14. The computer-readable medium of claim 13 wherein said network is a virtually-wired switching network and said first port couples switches in said network and said second port is coupled to a host device.

15. The computer-readable medium of claim 13, wherein b) of said method comprises tracing a topology of said network to determine said second port, wherein said network comprises a virtually-wired switching fabric and said second port is at the edge of said fabric.

16. The computer-readable medium of claim 15, wherein said method further comprises:
c) taking corrective action at said second port, wherein said second port is coupled to a host device.

17. The computer-readable medium of claim 15, wherein said method further comprises:
c) disabling said second port, wherein said network is a virtually-wired switching fabric and said second port is at the edge of said fabric.

18. The computer-readable medium of claim 13 wherein a) of said method comprises reading a bridge table to determine learned addresses at said first port.

19. The computer-readable medium of claim 13 wherein a) of said method is repeated for each interconnect port in said network, wherein said network comprises a plurality of switches.

20. The computer-readable medium of claim 13, wherein said method further comprises:
c) determining changes in physical topology of said network.

21. The computer-readable medium of claim 20 wherein c) of said method comprises comparing a physical description of said network with a stored physical description of said network.

22. A method of managing a network, said method comprising:
a) configuring a switch in said network to forward a packet received at a first port if an address associated with said packet is authorized for said first port;
b) forwarding said packet if said address is authorized; and
c) comparing a set of learned addresses against a set of expected addresses, said learned addresses comprising addresses associated with packets processed at a second port, said expected addresses derived from an expected configuration of said network.

23. The method of claim 22, further comprising:
d) tracing a topology of said network to find a third port where an unexpected address entered said network, said third port coupled to a device having a media access control (MAC address) that is said unexpected address.

24. The method of claim 23, further comprising:
e) disabling said third port, wherein said network is a virtually-wired switching fabric and said third port is at the edge of said fabric.

25. The method of claim 22, further comprising:
d) dropping said packet if said address is not authorized.

26. The method of claim 22, wherein a) comprises programming a switch in said network to recognize authorized addresses for said first port.

27. The method of claim 22, wherein b) further comprises forwarding said packet to a host device if said address is authorized for said first port, said first port coupled to said host device.

28. The method of claim 22, further comprising:
d) determining changes in physical topology of said network.

29. The method claim 28 wherein d) comprises comparing a physical description of said network with a stored physical description of said network.

30. The method of claim 29 wherein said address is a media access control (MAC) address and wherein said network comprises a virtually-wired switching fabric.

31. A network comprising:
a plurality switches;
said switches interconnected and configured to control communication between a plurality of devices coupled to said network; and
a first switch of said plurality configured to detect a packet having an unauthorized media access control (MAC) address.

32. The network of claim 31, wherein:
said first switch is further configured to forward said packet if said address is authorized.

33. The network of claim 31, wherein:
said first switch is further configured to drop said packet if said address is not authorized.

34. The network of claim 31, wherein there is a one-to-one mapping between ports of said switches and ports of said devices.
